(19) United States
(12) Patent Application Publication
(10) Pub. No.: US 2025/0258319 A1
(43) Pub. Date: Aug. 14, 2025

(54) Joint metasurface optics/image processing co-design for ultra-thin computational sensors and imagers

(71) Applicant: The Broad of Trustees of the Leland Stanford Junior University, Stanford, CA (US)

(72) Inventors: David G. Stork, Portola Valley, CA (US); Mark L. Brongersma, Menlo Park, CA (US)

(21) Appl. No.: 19/052,997

(22) Filed: Feb. 13, 2025

Related U.S. Application Data
(60) Provisional application No. 63/553,021, filed on Feb. 13, 2024.

(51) Int. Cl. G02B 1/00; G02B 27/00

(52) U.S. Cl. CPC G02B 1/002; G02B 27/0012; G02B 27/0075

(57) ABSTRACT

Although nonlocal optical metasurfaces have been used to reduce free space propagation distance in optical systems, the resulting aberrations are novel and difficult to eliminate via optical design. In this work, we consider combining such optical metasurfaces with digital image processing to compensate for these aberrations. Suitable optimization metrics for such designs can be imaging metrics such as mean square error or point spread function, or non-imaging metrics such as recognition accuracy, motion tracking accuracy, etc.

### CROSS REFERENCE TO RELATED APPLICATIONS

This application claims priority from U.S. Provisional Patent Application 63/553,021 filed Feb. 13, 2024, which is incorporated herein by reference.

### GOVERNMENT SPONSORSHIP

None.

### FIELD OF THE INVENTION

This invention relates to reducing free-space propagation distance in optical imaging systems, for both imaging and non-imaging applications.

### BACKGROUND

Two of the main reasons conventional optical systems tend to be large and bulky are the size of the components themselves (e.g., lens elements) and free space propagation distance. Recent work on optical metasurfaces has led to the idea of reducing optical system size by replacing conventional optical elements such as lenses with metasurfaces. However, in such cases the free space propagation distances remains large, limiting the size reduction that is possible.

More recently, nonlocal metasurfaces have been developed, where light incident on a metasurface is laterally propagated along the surface of a metasurface for some distance before being emitted from the metasurface. Metasurfaces of this kind offer the possibility of significantly reducing the free space propagation distance, thereby leading to much more compact optical system designs than previously possible.

However, such nonlocal metasurfaces tend to have significant aberrations that must be corrected in order to obtain high image quality (or high performance in non-imaging applications). Furthermore, these aberrations are novel, since they do not result from the deviation of shapes of spherically curved lenses from shapes that are ideal for imaging. Accordingly, it would be an advance in the art to provide improved free space reduction with nonlocal optical metasurfaces.

### SUMMARY

This work considers combined design of nonlocal optical metasurfaces and imaging processing to compensate for these novel aberrations. Such combined design can be sequential design (i.e., metasurface is designed first, then the image processing is designed to compensate for the aberrations fixed by the metasurface design) or, more preferably, joint design (i.e., metasurface and image processing are designed simultaneously).

Such joint design can be an end-to-end design system including an electromagnetic field simulation (for the metasurface lens or other optical element) and digital image processing, in which design parameters of the optical and the digital system are adjusted for optimal end-to-end system performance (imaging, sensing, object recognition, motion sensing, etc.).

The result of such a design can be an optical imaging device including a nonlocal metasurface optical element (with or without traditional glass or plastic lens elements), digital image sensor array, and a computing device that processes the sensed image so as to correct or compensate the inevitable distortions in the sensed image arising from the “imperfect” optics of the optical elements.

This work enables reduction of the optical path (thickness) of optical sensors, imagers and other devices while preserving high-quality final digital image or sensor accuracy. The main advantages are reduced size (mostly from reduced free space propagation distance) and reduced hardware cost.

Applications include, but are not limited to: mobile phone cameras, mobile phone sensors, medical image sensors, agricultural and environmental sensors, and machine inspection systems.

This work has applications beyond imaging—in particular, sensing and tracking. Here an electro-optical system could be used for reading a bar code or QR code, recognizing/counting human faces, detecting changes in the shape of a machine part as it is degraded through wear, and so forth. In such cases, the metasurface optics and the digital image processing can be designed to optimize a target or global merit function tailored to the sensing application at hand, and this could differ from the traditional image-quality metrics of mean-squared-error, peak signal-to-noise, and so on. Thus, for a bar-code reader the merit function would be the accuracy of code reading; for counting faces it would be the accuracy or precision/recall of face detection; for machine inspection it would be the geometric distortion in the image of a target part (smaller is better), and so forth

A related application is visual tracking, as might be used in an autonomous drone tracking a marker on a landing site while navigating for a landing. Here the merit function would be some measure of the mean-squared error in position over time (not pixel value), where perfect tracking would mean the sensor correctly reports the visual location of the tracked object at every moment.

### BRIEF DESCRIPTION OF THE DRAWINGS

FIG. 1 schematically shows a nonlocal optical metasurface.

FIG. 2 shows an exemplary embodiment of the invention.

FIGS. 3A-B show a first example of compensating nonlocal metasurface aberrations with digital image processing.

FIG. 4 show an exemplary design tradeoff for free-space reduction (Cᵥ) vs. image fidelity (mean-square-error) FIG. 5 shows amplitude and phase of a simulated nonlocal metasurface.

FIG. 6 shows a simulated point-spread function of the metasurface of FIG. 5.

FIG. 7A show a simulated test pattern for a system having ten stacked metasurfaces of FIG. 5.

FIG. 7B shows a simulated test pattern after appropriate image processing of the image of FIG. 7A.

### DETAILED DESCRIPTION

### Free-Space Reduction in Metasurface-Based Imagers and Sensors

Metasurface optical elements have reduced free space in multi-element, compound lens systems by replacing traditional glass or plastic lens elements, thereby reducing the optical path length. Nevertheless, such optical systems have remaining free space required for the focusing of the metasurface optical elements themselves. The central goal of this work is to reduce such free space as much as technically possible.

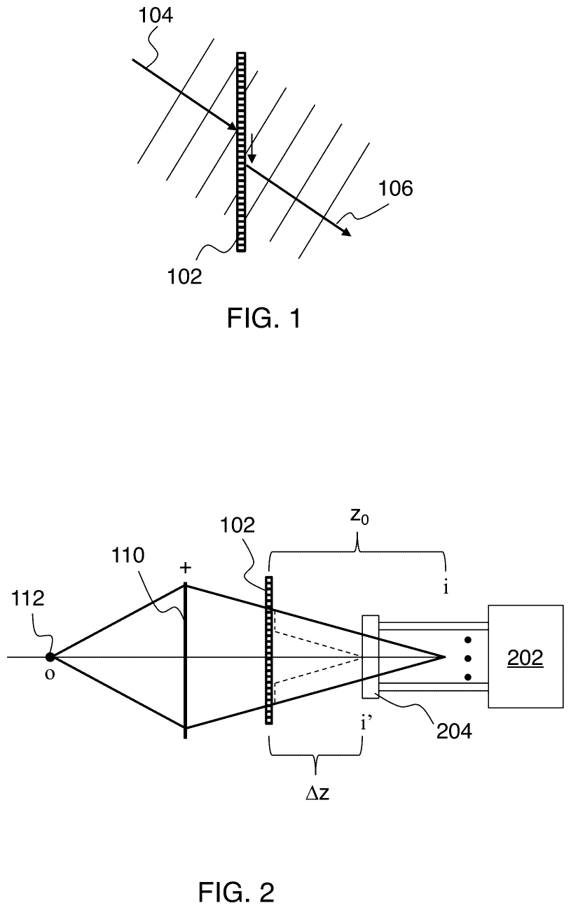

Recently, a number of research groups have developed nonlocal metasurface optical elements, in which light entering the metasurface at one location is transported through the surface (which acts as a waveguide), and emerges parallel to its initial direction of propagation, yet displaced, as shown in FIG. 1.

To appreciate the differences between local and nonlocal metasurfaces it is of value to understand how they are designed and how they operate at a conceptual level. In the design of most conventional metasurface structures, one arranges sub-wavelength nanostructures (i.e. meta-atoms) to achieve a transmission function t(x,y) that is dependent locally on the spatial coordinates x and y. For example, in a metalens the transmission function is designed to achieve a local space-variant phase shift that shapes the wavefront in the same fashion as a polished lens. In contrast, a nonlocal metasurfaces is designed to deliver a transmission function t(kₓ, k_{y}) that is dependent on the wavevectors kₓ and k_{y} of the incident light. In other words, this type of metasurface will differently manipulate light waves with different incident angles.

One important type of manipulation is to impart a phase delay on a plane wave 104 incident at a certain angle (FIG. 1). This can be accomplished in practice by having the light be coupled to a quasi-guided mode of the nonlocal metasurface 102. After some propagation time/distance, this light is released to produce a wave 106 with shifted optical wavefronts. The propagation distance/time is determined by the optical quality factor of the nonlocal metasurface.

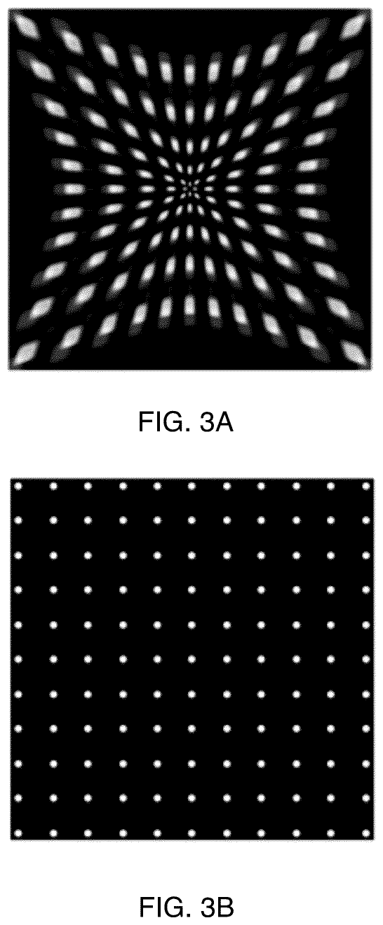

FIG. 2 shows an example of the free-space compression such a local metasurface can provide. Here we consider an exemplary imaging system having one positive (+) lens 110, where an object 112 at location o will be reimaged at a location i. A nonlocal metasurface 102 will be able to move the focus to a new location i′ by ensuring the coupling of light to the quasi-guided modes of the metasurface. Here z0 is a conventional propagation distance one would expect for this system, and Δz is the reduced propagation distance. Preferably, Δz/z₀ is 0.1 or less. A similar metric for free-space compression can be defined in any optical system. This example further includes an image sensor array 204 disposed at location i′ and including a 2D array of imaging elements, and a digital imaging processor 202 configured to receive data from the image sensor array.

To achieve proper imaging, rays incident on the metasurface at different angles need to incur different phase shifts. Previous work has demonstrated that this is possible through proper design. In this work we describe how the level of space compression can be enhanced beyond that of a nonlocal metasurface, the use of high-index materials, birefringent materials, the use of multiple metasurfaces, etc. through co-design with an computational back-end.

With proper design of the metasurface, we can engineer the magnitude of the displacements in a manner that is angle (i.e., k-vector) dependent, that is, manipulations that are typically performed in a Fourier plane. FIG. 2 shows how such optical displacement can be used to compress free space in metasurface-based imagers and sensors. Such free-space compression leads to an image that may suffer space-dependent distortion and blurring. Sophisticated digital image processing of this distorted image can lead to a high-fidelity final digital image.

Joint optics/image processing design has reduced free space in both traditional glass/plastic lens-based imaging systems and diffractive imaging systems. Much of this previous work, particularly theoretical analyses, centered on digital compensation of Seidel aberrations, such as spherical aberration, coma, astigmatism, curvature of field, and distortion.

There are fundamental limits upon the optical transformations that can be achieved with metasurfaces, including wavelength range, criterion blurring, variations in brightness, quantum efficiency, and so on. The associated optical aberrations arising in such systems have not been well characterized or understood—particularly those arising in the nonlocal metasurface optical systems of our central concern.

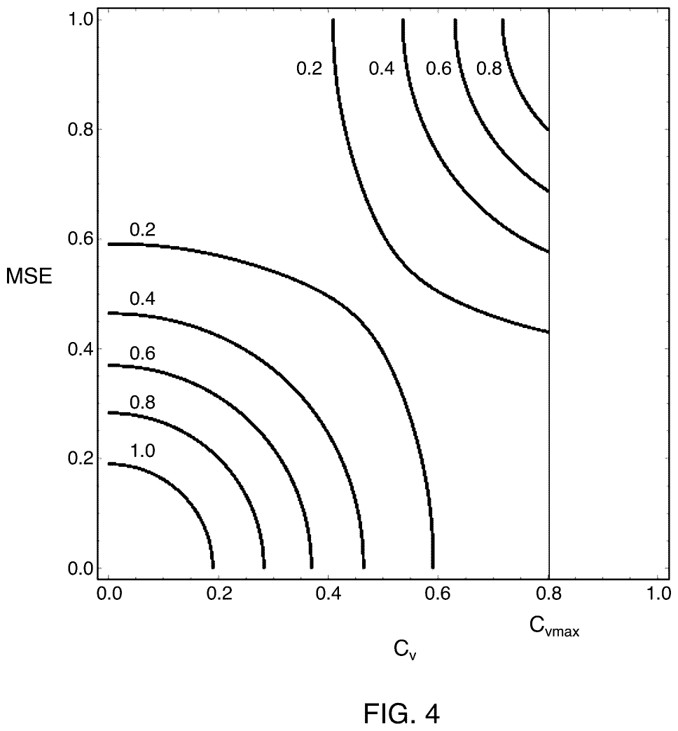

For this reason we consider both theoretical analysis and large-scale machine learning to correct optical aberrations throughout a range of optical designs and free-space compression ratios (Cᵥ), as shown schematically in FIGS. 3A-B. More specifically, FIG. 3A is a simulated raw sensor image showing wavelength-dependent and wavelength-independent spatial distortion and blurring of a scene of a rectilinear array of small, white, circular disks. FIG. 3B shows that space- and wavelength-dependent digital dewarping and image sharpening recovers a high-fidelity final image.

We consider such performance tradeoffs quantitatively, based on a large number of representative scenes or sensing stimuli, concentrating on properties such as: Free-space compression factor (C₂): The dimensionless ratio of the reduced free-space propagation distance to the original free-space propagation distance (e.g., Δz/z₀ as shown on FIG. 2).

Digital image fidelity (MSE): The pixel-wise root-mean-squared (or comparable) error between an ideal final digital image and the processed image, averaged over representative scene images.

Efficiency: The traditional photon efficiency or transparency of the nonlocal metasurface.

Angular resolution: The minimum resolvable field angle, analogous to the Rayleigh criterion but computed from the final (processed) digital image.

Field of view: Traditional full-width at half maximum angle, measured in degrees.

Numerical aperture (N.A.): The dimensionless measure of the range of angles of the incident light that the imaging system can accept.

Spectral waveband (Δλ): The range of sensed optical wavelengths.

Discriminability (d′): A dimensionless measure of the accuracy in detecting a target (e.g., human face or blood cell), as evident in receiver-operating characteristic (ROC) curves.

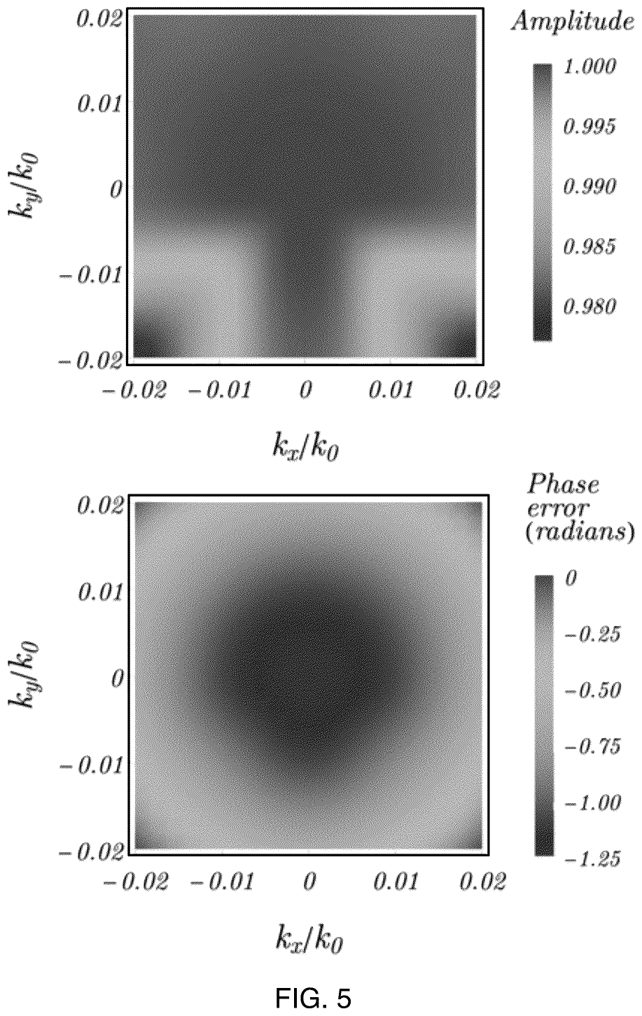

FIG. 4 shows an exemplary tradeoff along these lines. At low spatial compression ratios, the probability of attaining a small MSE (mean-square error) is high—that is, most digital images will be highly accurate. At large compression ratios (up to some maximum Cᵥₘₐₓ), the probability of attaining small MSE (accurate images) will be low. Contours of constant P(MSE|Cᵥ) are shown with solid lines. Plots of this type can characterize tradeoffs between other metrics, for instance MSE and spectral waveband (Δλ), or MSE versus field of view. Such analyses illuminate fundamental optical science and guide application developers. Such probabilities can be estimated from a large set of representative scene images.

We also consider ultra-thin application-specific image sensors and detectors, for example face detectors or medical sensors for counting blood cells.

### Simulation Results

We have verified through mathematical analysis and rigorous simulations that joint metasurface design and computational processing can yield more than an order-of-magnitude reduction in free space beyond metasurface design alone.

We first simulated a free-space-reducing metasurface optical design as reported in the literature, which compressed free space by approximating the free-space propagation of incident monochromatic plane wave through that space. FIG. 5 shows the amplitude and phase error (in radians) of the high-Q (>10⁴) but very low numerical aperture (N.A.˜0.01) system of that work, which yielded a space compression ratio (Cv˜144). More specifically, FIG. 5 shows amplitude and phase errors at the sensor plane for monochromatic light passing through a single-surface free-space compressing design. The amplitude is nearly 1.00 throughout the plane, that is, matched that of the incident wave, and the phase error closely matched that which would be due to free-space propagation. The axes represent the ratio of the horizontal and of the vertical components of the wave vector to that of the incident wave vector.

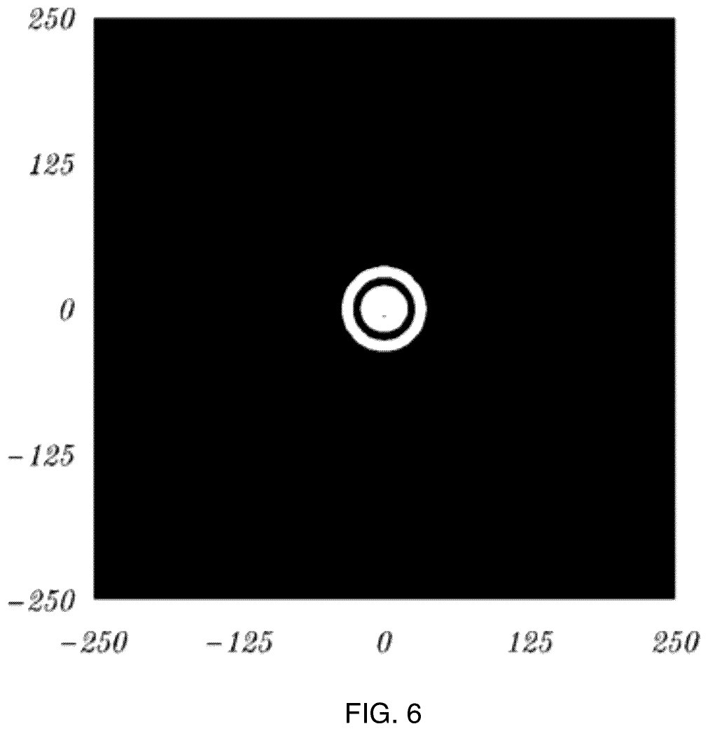

The (compact) point-spread function of this single-layer metasurface optical system on a 200×200 pixel sensor array is shown on FIG. 6. This purely optical design was optimized for space compression. Our efforts center on obtaining more extreme free-space reduction by joint application of optical design with digital image processing of the sensed image. After all, only the final digital image is of relevance; that is, we seek to produce a high-quality digital image while compressing free space more severely than prior methods.

To this end, we simulated light propagation through a stack of ten metasurfaces as described above—this led to a ten-fold reduction in free space. Of course the resulting optical image was significantly degraded and blurred compared to that of just a single layer. The point-spread function of this stacked system is far larger than that of the single-surface device (it is roughly a factor of 10× larger in both lateral directions).

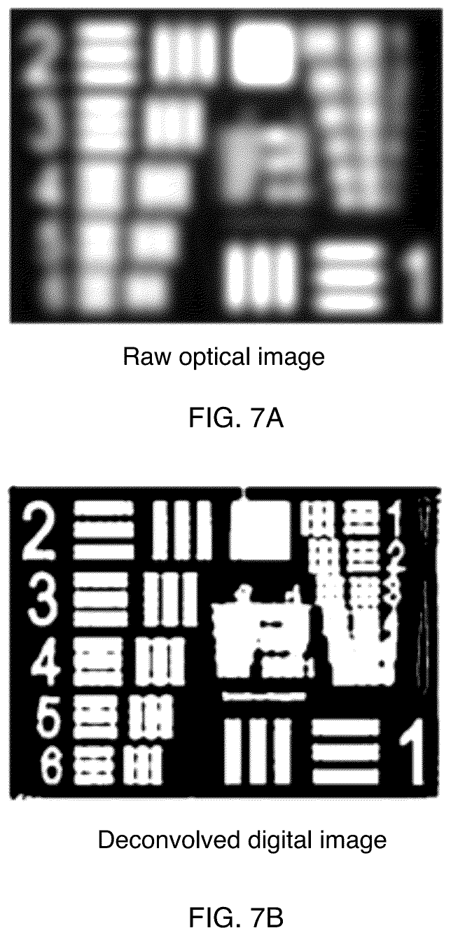

FIG. 7A shows a simulation of the image of an Air Force Resolution Test Chart on the sensor array after passing through ten stacked layers of the metasurface described above, computed by convolving the point-spread function of the stacked ten layer metasurface optical system with the Air Force Resolution Test Chart. This image is rather degraded and blurred—for instance the smaller numerals are illegible.

FIG. 7B shows the final digital image computed from the blurred optical image of FIG. 7A by the Richardson-Lucy deconvolution algorithm. This improved image matches that provided by an uncompressed imager closely (in an MSE sense). Richardson-Lucy deconvolution performs Bayesian inference of the ideal optical image given the knowledge of the point-spread function.

In short, with principled information-theoretic deconvolution exploiting the measured or simulated point-spread function of the stacked system, we produce a high-quality digital image with an order-of-magnitude improvement in free-space reduction over current state-of-the-art.

The results give us great confidence that our joint optics/signal processing approach can yield single-layer optical devices with two- or possibly more orders of magnitude improvement in free-space reduction over state-of-the-art optics-only approaches.

1. Apparatus comprising:
a nonlocal optical metasurface;
an image sensor array including a 2D array of imaging elements; and
a digital imaging processor configured to receive data from the image sensor array;
wherein the nonlocal optical metasurface is configured to receive incident light from a scene being viewed, and wherein the nonlocal optical metasurface is configured to provide transmitted light to the image sensor array;
wherein the nonlocal optical metasurface is configured to provide a lateral translation of the transmitted light relative to the incident light;
wherein the lateral translation is configured to enable a reduced propagation distance between the nonlocal optical metasurface and the image sensor array; and
wherein the digital image processor is configured to compensate for imaging artifacts due to the reduced propagation distance and/or the lateral translation.

2. The apparatus of claim 1, wherein the lateral translation depends on one or more optical parameters selected from the group consisting of: frequency, polarization and angle of incidence.

3. The apparatus of claim 1, wherein the reduced propagation distance is 10% or less of a corresponding conventional propagation distance.

4. The apparatus of claim 1, wherein the nonlocal metasurface is designed to provide a metasurface design, and wherein the image processor is designed using the metasurface design as a fixed input.

5. The apparatus of claim 1, wherein the nonlocal metasurface and the image processor are jointly designed.

6. The apparatus of claim 1, wherein the apparatus is configured as an imager.

7. The apparatus of claim 6, wherein the image processor is configured to optimize an imaging figure of merit.

8. The apparatus of claim 7, wherein the imaging figure of merit is selected from the group consisting of: mean-squared error, peak signal to noise, point spread function, and any combination thereof.

9. The apparatus of claim 1, wherein the apparatus is configured as a sensor.

10. The apparatus of claim 9, wherein the image processor configured to optimize a sensor figure of merit.

11. The apparatus of claim 1, wherein the apparatus is configured as an image recognizer.

12. The apparatus of claim 11, wherein the image processor is configured to optimize an image recognition figure of merit.
